(19) United States
(12) Patent Application Publication
(10) Pub. No.: US 2012/0307989 A1
(43) Pub. Date: Dec. 6, 2012

(54) METHOD AND APPARATUS FOR MULTIMEDIA CALLS

(76) Inventors: Michael J. Hawley, Naperville, IL (US); David S. Benco, Winfield, IL (US)

(21) Appl. No.: 13/151,423

(22) Filed: Jun. 2, 2011

(51) Int. Cl. H04M 11/00

(52) U.S. Cl. 379/93.01

(57) ABSTRACT

A multimedia call capability is disclosed. The multimedia call capability supports establishment of a data session in conjunction with a call, the data session being established between a user device and a multimedia answering point. The call may be directed to a Public Safety Answering Point (PSAP) and/or a private answering point. The multimedia call capability enables dynamic routing of call signaling of the user device to the answering point based on whether the user device includes a media content capture capability (e.g., a still camera, a video camera, and the like). The data session is configured to support propagation of media content from the user device to the answering point in conjunction with the call. The media content may include photographs, video, and the like, as well as various combinations thereof. The media content may be provided before, during, and/or after voice communications between the user of the user device and the operator at the answering point. In many types of situations, obtaining such additional media content from a user device would be invaluable to the operator handling the call and the personnel responding to the situation.

### TECHNICAL FIELD

The invention relates generally to communication networks and, more specifically but not exclusively, to handling calls in communication networks.

### BACKGROUND

In existing communication networks, there are numerous emergency reporting services.

### SUMMARY

Various deficiencies in the prior art are addressed by one or more embodiments for improving calls to answering points.

In one embodiment, an apparatus includes a processor and a memory, where the processor is configured to initiate a call from a user device supporting a media content capture capability, receive, at the user device, a request for establishment of a data session between the user device and a multimedia answering point, and propagate media content captured at the user device toward the multimedia answering point via the data session. In one embodiment, a method includes using a processor and a memory for initiating a call from a user device supporting a media content capture capability, receiving, at the user device, a request for establishment of a data session between the user device and a multimedia answering point, and propagating media content captured at the user device toward the multimedia answering point via the data session. In one embodiment, a computer readable storage medium stores instructions which, when executed by a processor, cause the processor to perform such a method.

In one embodiment, an apparatus includes a processor and a memory, where the processor is configured to receive call signaling indicative of a call initiated from a user device, determine whether the user device supports a media content capture capability, and determine routing of the call signaling based on the determination as to whether the user device supports a media content capture capability. In one embodiment, a method includes using a processor and a memory for receiving call signaling indicative of a call initiated from a user device, determining whether the user device supports a media content capture capability, and determining routing of the call signaling based on the determination as to whether the user device supports a media content capture capability. In one embodiment, a computer readable storage medium stores instructions which, when executed by a processor, cause the processor to perform such a method.

In one embodiment, an apparatus includes a processor and a memory, where the processor is configured to receive, at a multimedia answering point, call signaling indicative of a call initiated from a user device, and initiate establishment of a data session configured for propagating media content from the user device toward the multimedia answering point. In one embodiment, a method includes using a processor and a memory for receiving, at a multimedia answering point, call signaling indicative of a call initiated from a user device, and initiating establishment of a data session configured for propagating media content from the user device toward the multimedia answering point. In one embodiment, a computer readable storage medium stores instructions which, when executed by a processor, cause the processor to perform such a method.

In one embodiment, an apparatus includes a processor and a memory, where the processor is configured to receive a request to reestablish a data session between a multimedia answering point and a user device, wherein the data session is associated with a call initiated from the user device and propagate signaling configured to request reestablishment of the data session between the multimedia answering point and the user device. In one embodiment, a method includes using a processor and a memory for receiving a request to reestablish a data session between a multimedia answering point and a user device, wherein the data session is associated with a call initiated from the user device and propagating signaling configured to request reestablishment of the data session between the multimedia answering point and the user device. In one embodiment, a computer readable storage medium stores instructions which, when executed by a processor, cause the processor to perform such a method.

### BRIEF DESCRIPTION OF THE DRAWINGS

The teachings herein can be readily understood by considering the following detailed description in conjunction with the accompanying drawings, in which:

FIG. 1 depicts an exemplary communication system illustrating one embodiment of a multimedia emergency call capability;

FIGS. 2A and 2B depict the exemplary communication system of FIG. 1, illustrating emergency call signaling and associated session establishment where an emergency call is routed via a circuit-switched portion of the exemplary communication system of FIG. 1;

FIGS. 3A and 3B depict the exemplary communication system of FIG. 1, illustrating emergency call signaling and associated session establishment where an emergency call is routed via a data network portion of the exemplary communication system of FIG. 1;

FIG. 4 depicts one embodiment of a method for determining routing of an emergency call received from a user device;

FIG. 5 depicts one embodiment of a method for reestablishing a media session of a multimedia emergency call; and

FIG. 6 depicts a high-level block diagram of a computer suitable for use in performing the functions described herein.

To facilitate understanding, identical reference numerals have been used, where possible, to designate identical elements common to the figures.

### DETAILED DESCRIPTION OF ILLUSTRATIVE EMBODIMENTS

In general, a multimedia call capability is depicted and described herein, although various other capabilities also may be presented herein.

In at least some embodiments, the multimedia call capability supports establishment of a data session in conjunction with a call, the data session being established between a user device and a multimedia answering point. The call may be directed to a Public Safety Answering Point (PSAP) and/or a private answering point (e.g., a home security operations center/system of a home security company, a fire monitoring operations center/system of a fire monitoring company, or any other suitable type of answering point), which may be referred to more generally herein as answering points. In this sense, the call may be considered to be an emergency call, a security call, or any other type of call which may be placed to an answering point. Similarly, in this sense, the multimedia call capability may be considered to include a multimedia emergency call capability, a multimedia security capability, and/or any other type of capability which may be considered to fall within and/or be related to the multimedia call capability.

In at least some embodiments, the multimedia call capability supports establishment of a data session between a user device and a multimedia answering point in conjunction with an associated call, where the data session is configured to support propagation of media content (e.g., photographs, video, and the like, as well as various combinations thereof) from the user device to the multimedia answering point in conjunction with the associated call.

In at least some embodiments, the multimedia call capability enables handling of an emergency, security, or other type of call based on whether or not a user device from which the call is received supports a media content capture capability (which also may be referred to herein as a media content capture mechanism). In at least some embodiments, handling of a call based on whether or not the user device from which the call is received supports a media content capture capability includes determining routing of call establishment signaling of the call based on whether or not the user device from which the call is received supports a media content capture capability.

In at least some such embodiments, following establishment of a data session between a user device and a multimedia answering point, media content may be provided from the user device to the multimedia answering point prior to voice communications between the user of the user device and the operator handling the call (e.g., while the voice session is being established, after the voice session is established and while the user is waiting to speak to an operator, and the like), during voice communications between the user of the user device and the operator handling the call, after voice communications between the user of the user device and the operator handling the call, and the like, as well as various combinations thereof.

In many types of situations (e.g., emergency situations, security situations, and the like), obtaining such additional media content from a user device would be invaluable to the operator handling the call (e.g., the emergency services operator at a Public Safety Answering Point (PSAP), the operator at a private safety answering point, and the like) and/or response personnel responding in conjunction with the call (e.g., police departments, fire departments, medical services, the Federal Bureau of Investigation, the Federal Emergency Management Agency, Homeland Security, private response personnel of a company, and the like). For example, operators at an answering point could more completely assess the types of services that are required and quickly dispatch the associated personnel and/or equipment to the scene. For example, response personnel could better plan the actions to be taken (e.g., upon arriving at the scene for personnel responding to the scene, when a patient(s) arrives at a hospital for medical personnel handling patients from the scene, when a suspect(s) arrives at a police station for law enforcement officials handling suspects from the scene, and the like). Various other advantages of embodiments of the multimedia call capability will be apparent from the description provided herein.

Although primarily depicted and described herein with respect to embodiments of a multimedia emergency call capability (e.g., embodiments of the multimedia call capability in which the call is an emergency call that is directed to a Public Safety Answering Point (PSAP)), it is noted that the multimedia call capability may include various other embodiments, such as other types of multimedia emergency call capabilities, a multimedia security call capability (e.g., embodiments of the multimedia call capability in which the call is a security call, which may or may not be associated with an emergency, that is directed to a private safety answering point), and/or any other capabilities in which a data session is established for use in propagating media content in conjunction with a call to or other communication with an answering point.

Although primarily depicted and described herein with respect to providing various embodiments of the multimedia call capability within a particular type of communication network (illustratively, a network including a cellular wireless network and an Internet Protocol (IP) Multimedia Subsystem (IMS) network), it will be appreciated that various embodiments of the multimedia call capability may be provided using any various other suitable types of communication networks.

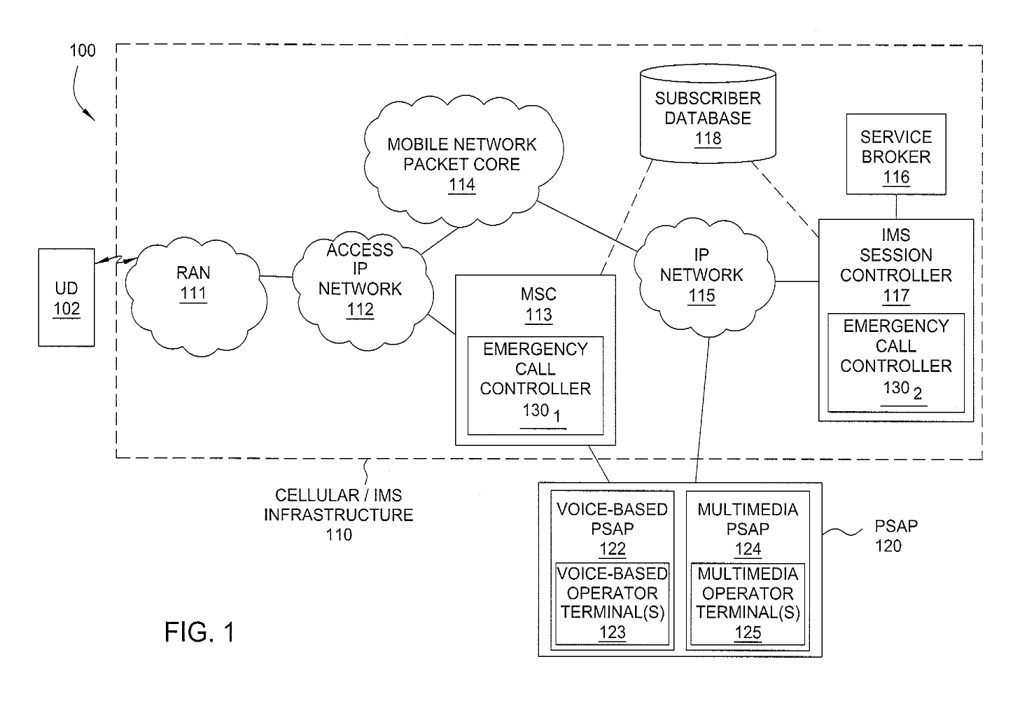

FIG. 1 depicts an exemplary communication system illustrating one embodiment of a multimedia emergency call capability.

As depicted in FIG. 1, the exemplary communication system 100 includes a user device (UD) 102, a cellular/IMS communication infrastructure 110, and a Public Safety Answering Point (PSAP) 120.

The UD 102 is a mobile device configured for wireless communication via a cellular wireless network. The UD 102 is configured for supporting dialing of a voice-based emergency call (e.g., via dialing of 911 or any other suitable number or code, via selection of an associated button or menu item, and the like). For example, the UD 102 may be any suitable mobile device, such as a cellular phone, a smart phone, a tablet computer with cellular access capabilities, or any other UD from which an emergency call may be initiated.

The UD 102 may or may not be configured to support a media content capture capability (although, for many embodiments depicted and described herein, an assumption is made that the UD 102 supports at least some form of a media content capture capability). In general, a media content capture capability includes a capability to capture one or more of photographs, video, and the like, as well as combinations thereof. For example, a media content capture capability of the UD 102 may include one or more of a still camera, a video camera, and like content capture capabilities/mechanisms, as well as various combinations thereof.

The cellular/IMS communication infrastructure 110 is configured to support establishment and use of one or more sessions configured to enable UD 102 to provide multimedia content within the context of an emergency call from UD 102.

The cellular/IMS communication infrastructure 110 includes a Radio Access Network (RAN) 111, an access IP network 112, a Mobile Switching Center (MSC) 113, a Mobile Network Packet Core (MNPC) 114, an IP network 115, a Service Broker 116, an IMS Session Controller 117, and a subscriber database 118.

The RAN 111 includes one or more base stations providing wireless access points via which UD 102 may access the cellular/IMS communication infrastructure 110. The RAN 111 is capable of communicating via access IP network 112, which is capable of handling communications for both MSC 113 and MNPC 114.

The MSC 113 is configured to handle circuit-switched voice calls associated with RAN 111. The MSC 113 is capable of communicating with PSAP 120. In one embodiment, MSC 113 includes an emergency call controller (ECC) 130₁ configured to provide various functions of the multimedia emergency calling capability (e.g., determining handling of an emergency call based on whether or not the UD from which the emergency call is received supports a media content capture capability, determining handling of an emergency call based on whether or not a multimedia PSAP is available, and various other functions).

The MNPC 114 is configured to handle packet-based voice and data sessions associated with RAN 111. The MNPC 114 includes various elements for supporting signaling and bearer sessions for packet-based voice calls and data sessions associated with RAN 111, where the types of elements of the MNPC 114 may depend on the type of wireless network. In a Universal Mobile Telecommunications System (UMTS)-based wireless network, for example, MNPC 114 may include elements such as Serving General Packet Radio Service (GPRS) Support Nodes (SGSNs), Gateway GPRS Support Nodes (GGSNs), and the like. In an LTE-based wireless network, for example, MNPC 114 may include elements such as Serving Gateways (SGWs), Packet Data Network (PDN) Gateways (PGWs), Mobility Management Entities (MMEs), and the like.

The Service Broker 116 is configured to support emergency call signaling, and may be configured to provide emergency-specific functionality (e.g., responding to a PSAP command to reestablish a dropped/terminated session with an emergency caller, specifying the type of session to be reestablished with the emergency caller (e.g., silent, voice-only, video-only, and so on), and the like) to the IMS Session Controller 117 and/or one or more other elements of cellular/IMS communication infrastructure 110. It is noted that at least a portion of the functions of Service Broker 116 may be provided by the associated Emergency Call Controller (illustratively, ECC 130₁ and/or ECC 130₂, depending on the embodiment).

The IMS Session Controller 117 is configured to provide session control functions for data sessions which are associated with RAN 111 and supported by MNPC 114. The IMS Session Controller 117 has access to subscriber database 118 and is capable of communicating with PSAP 120 (illustratively, via IP network 115). In one embodiment, the IMS Session Controller 117 includes an emergency call controller (ECC) 130₂ configured to provide various functions of the multimedia emergency calling capability (e.g., determining handling of an emergency call based on whether or not the UD from which the emergency call is received supports a media content capture capability, determining handling of an emergency call based on whether or not a multimedia PSAP is available, and various other functions).

The subscriber database 118 stores subscriber profiles for subscribers authorized to access the cellular/IMS communication infrastructure 110. In general, a subscriber profile for a subscriber may include information such as account information of the subscriber (e.g., personal information, billing and payment information, and the like), information associated with the UD of the subscriber, information indicative of services that the subscriber is authorized to use, current location information of the subscriber, call handling settings for the subscriber, and the like, as well as various combinations thereof. The information associated with the UD of the subscriber may include information indicative of whether or not the UD includes a media content capture capability, and also may specifically identify the type(s) of media content capture capability supported (e.g., only a still camera, only a video camera, still and video cameras, whether the still camera(s) and/or video camera(s) are forward-facing and/or rear-facing, and the like). The subscriber profile and associated subscriber information of a subscriber may be accessed based on any suitable input information (e.g., an International Mobile Equipment Identity (IMEI) of the UD of the subscriber, a telephone number of the UD of the subscriber, an address of the UD of the subscriber, and the like), which may be received as part of the emergency call signaling received from the UD when an emergency call is initiated from the UD. In 3G cellular networks, for example, the subscriber database 118 may be implemented as a Home Location Register (HLR). In IMS-based networks, for example, the subscriber database 118 may be implemented as a Home Subscriber Server (HSS). The subscriber database 118 may be implemented in any other suitable manner.

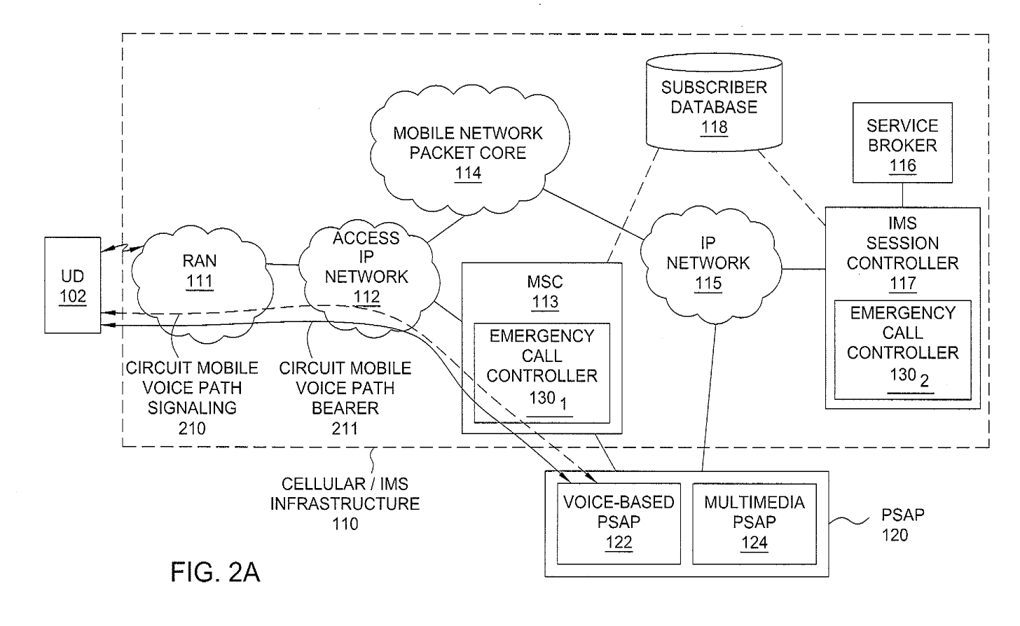

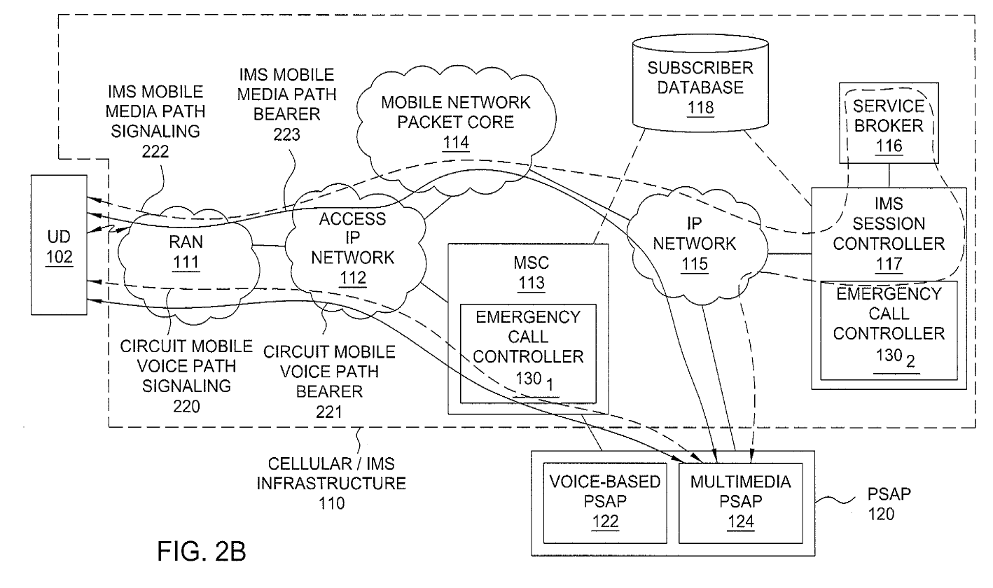

The PSAP 120 is a call center having emergency services operators who handle emergency calls routed to PSAP 120. As depicted in FIG. 2, the PSAP 120 includes a voice-based PSAP 122 (which represents a portion of PSAP 120 including operator terminals, and associated emergency services operators, handling voice-based emergency calls which do not include media content) and a multimedia PSAP 124 (which represents a portion of the PSAP 120 including operator terminals, and associated emergency services operators, handling multimedia emergency calls in which media content and, optionally, one or more other types of content, may be provided in conjunction with the emergency call). In one embodiment, routing of emergency calls to voice-based PSAP 122 or multimedia PSAP 124 of PSAP 120 is performed based on whether or not the UD 102 from which the emergency call is received supports a media content capture capability (and, where an assumption cannot be made that a multimedia PSAP is available, based on whether or not a multimedia PSAP is available to handle a multimedia emergency call).

The voice-based PSAP 122 is capable of handling voice-based emergency calls. As depicted in FIG. 1, voice-based PSAP 122 includes one or more voice-based operator terminals 123 via which emergency services operators may handle voice-based emergency calls. For example, in response to an incoming voice-based emergency call, an emergency services operator may use a voice-based operator terminal 123 to answer the emergency call, communicate with the calling party who placed the emergency call, communicate with emergency services personnel (e.g., for dispatching emergency services personnel to the scene of the emergency, for updating emergency services personnel regarding the situation at the scene of the emergency, and the like), terminate the emergency call, and the like. For example, a voice-based operator terminal 123 may include voice communication mechanisms (e.g., speakers, a microphone, a headset, and the like), one or more display mechanisms (e.g., for displaying information associated with the emergency call), and the like, as well as various combinations thereof. The typical operation of a voice-based PSAP, such as voice-based PSAP 122, will be understood by one skilled in the art.

The multimedia PSAP 124 is capable of handling multimedia emergency calls, including handling of multimedia content (e.g., voice content and one or more additional types of media content such as photographs, video, and the like) provided in conjunction with a multimedia emergency call.

In one embodiment, as depicted in FIG. 1, multimedia PSAP 124 includes one or more multimedia operator terminals 125 via which emergency services operators may handle multimedia emergency calls. For example, in response to an incoming multimedia emergency call, an emergency services operator may use a multimedia operator terminal 125 to answer the emergency call, verbally communicate with the calling party who placed the emergency call, view media content received in conjunction with the emergency call, communicate with emergency services personnel (e.g., for dispatching emergency services personnel to the scene of the emergency, for updating emergency services personnel regarding the situation at the scene of the emergency, and the like), terminate the emergency call, reestablish at least a portion of the emergency call, and the like. For example, a multimedia operator terminal 125 may include (1) voice communication capabilities enabling emergency services operators to verbally communicate with calling parties (e.g., speakers, a microphone, a headset, and the like) and (2) media presentation capabilities enabling presentation of additional media content such as photographs, video, and the like (e.g., processors, memory, one or more monitors or other content display devices, and the like). For example, a multimedia operator terminal 125 may be implemented as a computer including various hardware (e.g., a processor(s), memory, one or more monitors or other display devices, and the like) and associated software (e.g., voice communication control software, media content presentation software (e.g., one or more picture viewers, one or more video players, and so forth), and the like, as well as various combinations thereof.

In one embodiment, multimedia PSAP 124 may include one or more media content processing programs configured to process media content received at multimedia PSAP 124. The media content processing programs may be provided on the multimedia operator terminals 125 and/or on one or more other elements in communication with multimedia operator terminals 125. The media content processing programs may include programs such as pattern recognition programs, scene recognition programs, and the like. For example, where media content provided from UD 102 to multimedia PSAP 124 includes a tanker truck, automated recognition of the presence of the tanker truck may result in a presentation of an alert to the emergency services operator, such that the emergency services operator may request deployment of a fire department to the scene in case of a fire. For example, where media content provided from UD 102 to multimedia PSAP 124 includes smoke and/or other indicators of a fire, automated recognition of the possible presence of a fire may result in a presentation of an alert to the emergency services operator, such that the emergency services operator may request deployment of a fire department to the scene in case of a fire. For example, where media content provided from UD 102 to multimedia PSAP 124 includes a mile marker sign, automated recognition of the mile marker sign may be used to automatically determine the location of the emergency more precisely. For example, where media content provided from UD 102 to multimedia PSAP 124 includes a handgun, automated recognition of the handgun may result in presentation of an alert to the emergency services operator, such that the emergency services operator may inform emergency services personnel of the presence of the handgun at the scene of the emergency. Although primarily depicted and described with respect to examples in which additional media content processing capabilities are used to present additional information to emergency services operators, it is noted that additional media content processing capabilities also may be used to automatically trigger various actions to be taken in conjunction with handling of emergency situations (e.g., automated emergency location determination functions, automated emergency services personnel deployment functions, and the like, as well as various combinations thereof). It will be appreciated that the foregoing examples are merely a few of the many ways in which additional media content processing capabilities may be used for presenting additional information for use by emergency services operators, automatically triggering actions to be taken in conjunction with handling of emergency situations, and the like, as well as various combinations thereof. It is noted that, although primarily depicted and described with respect to embodiments in which multimedia PSAP 124 is capable of performing additional processing on media content, in various other embodiments in which one or more data sessions may be used to provide one or more other types of information (e.g., UD geo-location information, temperature readings, and the like) from UD 102 to multimedia PSAP 124 in conjunction with an emergency call, multimedia PSAP 124 may be capable of performing additional processing associated with the one or more one or more other types of information provided from UD 102 to multimedia PSAP 124 in conjunction with the emergency call.

Although primarily described with respect to embodiments in which each of the emergency services operators of PSAP 120 has an associated operator terminal and handles emergency calls independently of other emergency services operators at PSAP 120, it will be appreciated that PSAP 120 also may include one or more common communication/presentation interfaces via which multiple emergency services operators may communicate and/or review/analyze content together. For example, voice-based PSAP 122 may include one or more common voice communication interfaces via which multiple emergency services operators may listen to and/or speak to a calling party. For example, multimedia PSAP 124 may include one or more common media presentation interfaces via which multiple emergency services operators may review and analyze media content together (e.g., projection screens enabling presentation of media content to any suitable number of emergency services operators who may be involved in analyzing media content associated with an emergency). Various other capabilities for communication with calling parties and/or review/analysis of media content may be employed within PSAP 120 for use in handling emergency calls routed to PSAP 120.

Although primarily depicted and described herein with respect to embodiments in which the voice-based PSAP 122 and multimedia PSAP 124 are provided within the same PSAP call center (e.g., as separate sets of operator terminals located within the same PSAP call center), it is noted that the voice-based PSAP 122 and multimedia PSAP 124 also may be located with the different PSAP call centers.

Although primarily depicted and described herein with respect to embodiments in which the PSAP 120 is independent of the cellular/IMS communication infrastructure 110, it is noted that all or part of PSAP 120 may be considered to be part of cellular/IMS communication infrastructure 110.

As described herein, the exemplary communication system 100 is configured for handling an emergency call based on whether or not a UD from which the emergency call is received supports a media content capture capability. A user of UD 102 initiates an emergency call (e.g., by dialing 911 or any other suitable number or code). The UD 102 sends emergency call signaling in response to initiation of the emergency call. The emergency call signaling is received by RAN 111 and may be passed either to MSC 113 or MNPC 114 (e.g., depending on the type and/or configuration of the underlying cellular network via which the emergency call is initiated, which may control whether or not the incoming call is handled in the circuit-switched or packet-switched portion of the underlying communication network). For example, in some cellular networks, voice calls are handled in a circuit-switched portion of the network and, in this case, the emergency call signaling received by RAN 111 is passed to MSC 113. Similarly, for example, in some cellular networks, voice calls are handled in a packet-switched portion of the network and, in this case, the emergency call signaling received by RAN 111 is passed to MNPC 114.

In the case in which the emergency call signaling is propagated toward MSC 113, the MSC 113 is configured to determine appropriate routing of the emergency call signaling based on whether or not the UD 102 from which the emergency call is received supports a media content capture capability. The MSC 113 may determine whether or not UD 102 supports a media content capture capability in any suitable manner (e.g., from information included within the emergency call signaling received from the UD 102, by querying the subscriber database 118 for device capability information (e.g., using information received as part of the emergency call signaling received at MSC 113), and the like, as well as various combinations thereof).

In the case in which the MSC 113 determines that UD 102 does not support a media content capture capability, MSC 113 routes the emergency call signaling toward voice-based PSAP 122 for establishing a voice session between voice-based PSAP 122 and UD 102. This is represented in FIG. 2A as circuit mobile voice path signaling 210 (between UD 102 and voice-based PSAP 122 via RAN 111, access IP network 112, and MSC 113), which is used to establish an associated circuit mobile voice path bearer 211 between UD 102 and voice-based PSAP 122 via RAN 111, access IP network 112, and MSC 113. It will be appreciated that circuit mobile voice path signaling 210 and circuit mobile voice path bearer 211 also may be referred to more generally herein as emergency call signaling and a voice session, respectively.

In the case in which the MSC 113 determines that UD 102 does support a media content capture capability, separate voice and media sessions may be established between UD 102 and multimedia PSAP 124 for enabling a multimedia emergency call for UD 102. This is represented in FIG. 2B, as described below.

As illustrated in FIG. 2B, MSC 113 routes the emergency call signaling toward multimedia PSAP 124 for establishing a voice session between multimedia PSAP 124 and UD 102. This is represented in FIG. 2B as circuit mobile voice path signaling 220 (between UD 102 and multimedia PSAP 124 via RAN 111, access IP network 112, and MSC 113), which is used to establish an associated circuit mobile voice path bearer 221 between UD 102 and multimedia PSAP 124 via MSC 113. It will be appreciated that circuit mobile voice path signaling 220 and circuit mobile voice path bearer 221 also may be referred to more generally herein as emergency call signaling and a voice session, respectively.

As further illustrated in FIG. 2B, in this case in which the MSC 113 routes the emergency call signaling toward multimedia PSAP 124, multimedia PSAP 124 may be configured for initiating establishment of a media session between UD 102 and multimedia PSAP 124. In this case, multimedia PSAP 124 initiates media session establishment signaling toward IMS Session Controller 117 via IP network 115. The IMS Session Controller 117 receives the media session establishment signaling, identifies the UD 102 for which the media session establishment signaling is intended, and initiates routing of the media session establishment signaling toward UD 102 for establishing a media session between multimedia PSAP 124 and UD 102. This is represented in FIG. 2B as IMS mobile media path signaling 222 between UD 102 and multimedia PSAP 124, which is used to establish an associated IMS mobile media path bearer 223 between UD 102 and multimedia PSAP 124. The IMS mobile media path signaling 222 traverses a path from multimedia PSAP 124 to UD 102 which includes IP network 115, IMS session Controller 117, Service Broker 116, IMS Session Controller 117, IP network 115, MNPC 114, access IP network 112, and RAN 111. The IMS mobile media path bearer 223 traverses a path from UD 102 to multimedia PSAP 124 which includes RAN 111, access IP network 112, MNPC 114, and IP network 115. It will be appreciated that IMS mobile media path signaling 222 and IMS mobile media path bearer 223 also may be referred to more generally herein as emergency call signaling and a media session, respectively.

Although primarily depicted and described herein with respect to embodiments in which MSC 113 determines routing of emergency calls, it is noted that this function may be performed by any other suitable element(s) of the circuit-switched portion of the underlying communication network.

In the case in which the emergency call signaling is propagated toward MNPC 114, the MNPC 114 is configured to propagate the emergency call signaling toward components of the associated IMS network (illustratively, to IP network 115 and then to IMS Session Controller 117). The IMS Session Controller 117 is configured to determine appropriate routing of the emergency call signaling based on whether or not the UD 102 from which the emergency call is received supports a media content capture capability. The IMS Session Controller 117 may determine whether or not UD 102 supports a media content capture capability in any suitable manner (e.g., from information included within the emergency call signaling received from the UD 102, by querying the subscriber database 118 for device capability information (e.g., using information received as part of the emergency call signaling received at IMS Session Controller 117), and the like, as well as various combinations thereof).

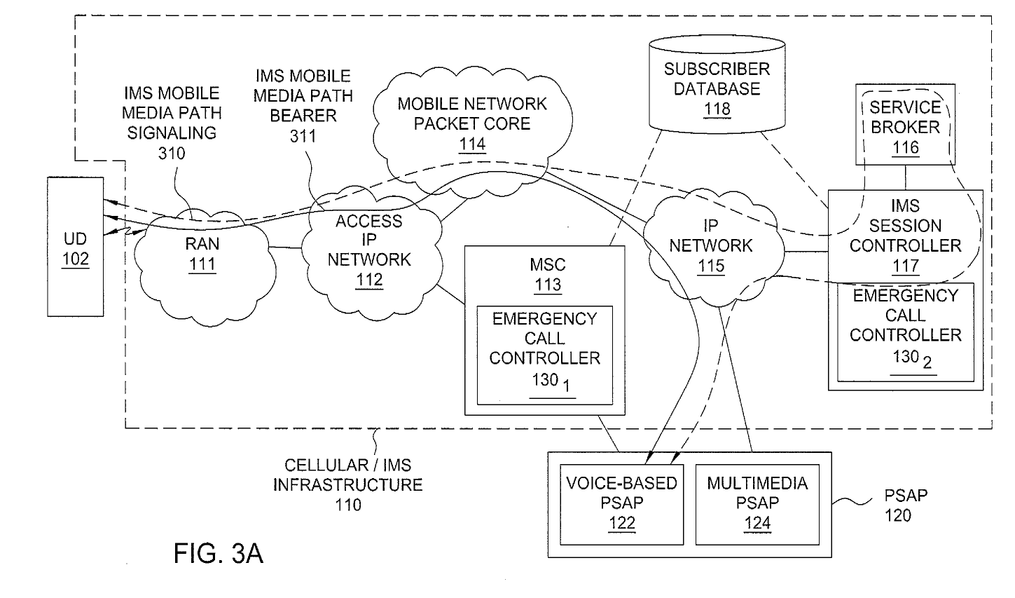

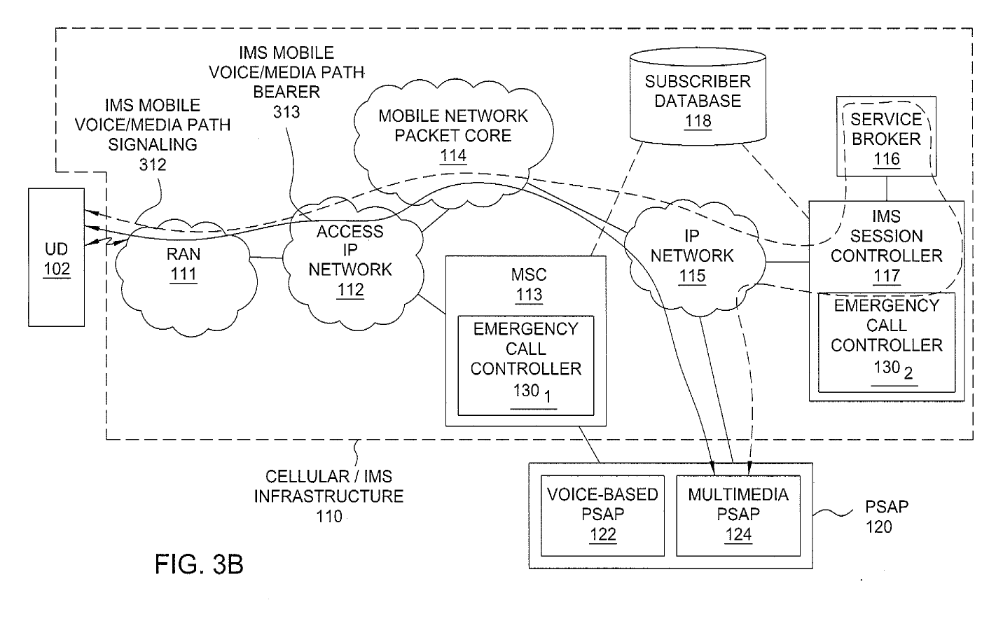

In the case in which the IMS Session Controller 117 determines that UD 102 does not support a media content capture capability, IMS Session Controller 117 routes the emergency call signaling toward voice-based PSAP 122 for establishing a voice session between voice-based PSAP 122 and UD 102. This is represented in FIG. 3A as IMS mobile voice path signaling 310, which is used to establish an associated IMS mobile voice path bearer 311 between UD 102 and voice-based PSAP 122. The IMS mobile voice path signaling 310 traverses a path from multimedia UD 102 to voice-based PSAP 122 which includes RAN 111, access IP network 112, MNPC 114, IP network 115, IMS Session Controller 117, Service Broker 116, IMS Session Controller 117, and IP network 115. The IMS mobile voice path bearer 311 traverses a path from UD 102 to multimedia PSAP 124 which includes RAN 111, access IP network 112, MNPC 114, and IP network 115. It will be appreciated that IMS mobile voice path signaling 310 and IMS mobile voice path bearer 311 also may be referred to more generally herein as emergency call signaling and a voice session, respectively.

In the case in which the IMS Session Controller 117 determines that UD 102 does support a media content capture capability, IMS Session Controller 117 routes the emergency call signaling toward multimedia PSAP 124 for establishment of a multimedia session between multimedia PSAP 124 and UD 102. This is represented in FIG. 3B as IMS mobile voice/media path signaling 312 between UD 102 and media PSAP 124, which may be used to establish an associated IMS mobile voice/media path bearer 313 between UD 102 and media PSAP 124. The IMS mobile voice/media path signaling 312 traverses a path similar to that of IMS mobile voice path signaling 310 depicted and described with respect to FIG. 3A. The IMS mobile voice/media path bearer 313 traverses a path similar to that of IMS mobile voice path bearer 311 depicted and described with respect to FIG. 3A. It will be appreciated that IMS mobile voice/media path signaling 312 and IMS mobile voice/media path bearer 313 also may be referred to more generally herein as emergency call signaling and a multimedia session, respectively.

Although primarily depicted and described herein with respect to embodiments in which IMS Session Controller 117 determines routing of emergency calls, it is noted that this function may be performed by any other suitable element(s) of the packet-switched portion of the underlying communication network (e.g., one or more other IMS network components, one or more other components, and the like).

In the cases in which an emergency call is routed toward multimedia PSAP 124, the multimedia PSAP 124 receives the emergency call signaling and a media session is established between the UD 102 and the multimedia PSAP 124. As noted above, the media session may be (1) a multimedia session providing voice as well as other media content (e.g., photos, video, and the like) to multimedia PSAP 124, or (2) a media session that is separate from an associated voice session where the voice session provides voice content to multimedia PSAP 124 and the media session provides one or more other types of media content (e.g., photos, video, and the like) to multimedia PSAP 124. It is noted that media sessions (e.g., transporting media content without associated voice) and multimedia sessions (transporting media content and associated voice) may be referred to herein as media session (as they each include some form of media, such as photographs, video, and the like) or, more generally, as data sessions.

Following establishment of a media session (e.g., a media session or a multimedia session) between UD 102 and multimedia PSAP 124, the UD 102 may then begin providing media content to multimedia PSAP 124 via the media session. The UD 102 may provide media content to multimedia PSAP 124 in response to any suitable trigger condition(s).

In one embodiment, for example, UD 102 is configured to automatically begin providing media content via the media session when the media session is established.

In one embodiment, for example, the UD 102 is configured to receive a request for media content from multimedia PSAP 124 (e.g., a request initiated automatically by multimedia PSAP 124, a request initiated manually by an emergency services operator via a multimedia operator terminal 125 of the multimedia PSAP 124, and the like). In one embodiment, in response to such a request, the UD 102 is configured to automatically begin providing media content via the media session. In one embodiment, in response to such a request, the UD 102 is configured to process the request for determining whether or not to begin providing media content via the media session (e.g., the determination is made automatically by UD 102 without user intervention). In one embodiment, in response to such a request, the UD 102 is configured to present an indication of the request via the UD 102, such that the user of UD 102 may provide an indication as to whether or not the UD 102 should begin providing media content via the media session. Although primarily depicted and described with respect to embodiments in which the request is received at the UD 102 from the multimedia PSAP 124, it is noted that such a request may be received from any other suitable network element or elements configured for initiating such a request.

In one embodiment, for example, the UD 102 is configured to initiate a request to provide media content, which is then routed to the multimedia PSAP 124 for processing at multimedia PSAP 124. The request may be processed automatically at the multimedia PSAP 124, such that the multimedia PSAP 124 automatically sends a reply to the UD 102 for indicating whether or not the UD 102 should begin providing media content via the media session. The request may be reviewed by an emergency service operator via a multimedia operator terminal 125 of multimedia PSAP 124 such that the emergency service operator may provide a manual indication as to whether or not the UD 102 should begin providing media content via the media session (which may then be communicated from multimedia PSAP 124 to the UD 102 for indicating whether or not the UD 102 should begin providing media content via the media session. Although primarily depicted and described with respect to embodiments in which the request is sent from the UD 102 to the multimedia PSAP 124, it is noted that such a request may be sent to any other suitable network element or elements configured for processing and responding to such a request.

In at least some such embodiments, in which a request for media content is initiated, the request may be denied. For example, the multimedia PSAP 124 may deny a request received from UD 102. For example, the UD 102 may deny a request received from multimedia PSAP 124. In at least some embodiments, denial of a request may be final, such that another request will need to be initiated and accepted before media content is provided via the media session. In at least some embodiments, denial of a request may be temporary (e.g., until such a time that the request is later accepted). It is noted that such embodiments may be used where, initially, there is no need for media content to be provided in conjunction with the emergency call, so a request for multimedia content may be rejected (or never sent); however, later in the emergency call session, the user needs to transmit some type of media.

The UD 102 may begin providing media content to multimedia PSAP 124 in response to any other suitable trigger which may be detected/initiated locally and/or received from any suitable network element.

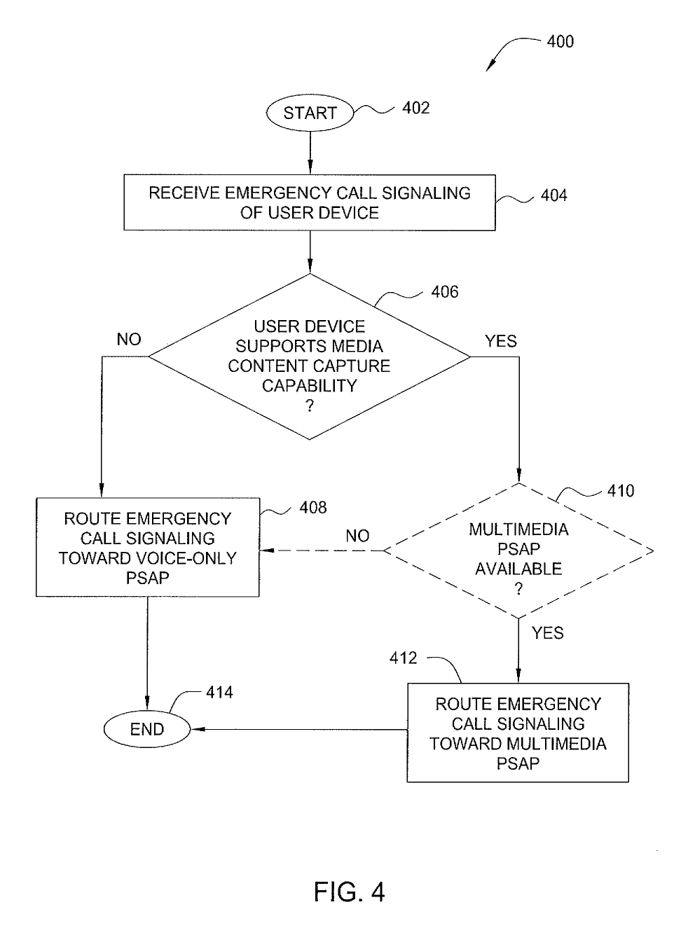

As will be appreciated from the foregoing description, the process performed for determining handling of emergency calls may be performed by many different network elements and, thus, may be generalized as depicted and described with respect to FIG. 4.

FIG. 4 depicts one embodiment of a method for determining routing of an emergency call received from a user device.

At step 402, method 400 begins.

At step 404, emergency call signaling of the UD is received. For example, the emergency call signaling of the UD may be received at an MSC, an IMS Session Controller, or any other suitable element which may be executing steps of method 400.

At step 406, a determination is made as to whether the UD from which the emergency call is received supports a media content capture capability. This also may be referred to herein as a determination as to whether the UD is capable of capturing and providing media content, such that media content may be provided to a multimedia PSAP. In one embodiment, determination as to whether the UD from which the emergency call is received supports a media content capture capability may be made by querying one or more databases for determining device capability information associated with the UD (e.g., querying a subscriber database and/or any other suitable source of such information for determining whether the UD supports a media content capture capability and, optionally, details regarding the type(s)/specifics of the media content capture capability or capabilities supported by the UD). In one embodiment, this determination may be made using information included within the emergency call signaling received from the UD (e.g., where the UD provides, within the emergency call signaling, an indication as to whether or not the UD supports a media content capture capability and, optionally, indicators for the type(s)/specifics of the media content capture capability or capabilities supported by the UD). In one embodiment, a combination of such embodiments may be used to determine whether the UD from which the emergency call is received supports a media content capture capability (e.g., when the emergency call signaling includes a basic indication that at least some form of media content capture capability is supported by the UD, then the element receiving the emergency call signaling can query one or more databases for determining the type(s)/specifics of the media content capture capability or capabilities supported by the UD).

If a determination is made that the UD does not support a media content capture capability, method 400 proceeds to step 408, at which point the emergency call signaling is routed toward a voice-based PSAP. From step 408, method 400 proceeds to step 414, where method 400 ends.

If a determination is made that the UD does support a media content capture capability, method 400 may proceed to step 410 or, alternatively, may skip step 410 and proceed directly to step 412.

In one embodiment, as noted above, method 400 proceeds to step 410, which is indicated as being an optional step. At step 410, a determination is made as to whether or not a multimedia PSAP is available for handling the emergency call from the UD. For example, this may be useful where an assumption cannot be made that a multimedia PSAP is available to handle the emergency call of the UD. If a determination is made that a multimedia PSAP is not available, method 400 proceeds to step 408, at which point the emergency call signaling is routed toward a voice-based PSAP (e.g., although the UD is capable of providing media content, there is no multimedia PSAP available for handling the media content in addition to the voice content of the emergency call). If a determination is made that a multimedia PSAP is available, method 400 proceeds to step 412, at which point the emergency call signaling is routed toward a multimedia PSAP. From steps 408 and 412, method 400 proceeds to step 414, where method 400 ends.

In one embodiment, as noted above, method 400 skips step 410 and proceed directly to step 412. This may be useful where an assumption can be made that a multimedia PSAP is available, such that there is no need for a determination as to whether a multimedia PSAP is available to handle the emergency call of the UD (i.e., there is no need for step 410). In this case, at step 412, the emergency call signaling is routed toward a multimedia PSAP. From step 412, method 400 proceeds to step 414, where method 400 ends.

As indicated above, method 400 ends at step 414. Although depicted and described as ending (for purposes of clarity), it will be appreciated that various other steps may be performed in order to support the emergency call placed by the user of the UD (e.g., propagating the emergency call signaling of the UD, establishing one or more sessions required for transporting content provided via the UD during the emergency call, propagating content from the UD to a PSAP, and the like, as well as various combinations thereof).

Although depicted and described herein in a manner for illustrating different embodiments in which there may be an additional determination regarding the availability of a multimedia PSAP to handle the emergency call from the UD, it is noted that method 400 of FIG. 4 also may be represented more generally as including steps of receiving emergency call signaling of the UD, determining whether the UD from which the emergency call signaling is received supports a media content capture capability, and determining, based on whether or not the UD from which the emergency call signaling is received supports a media content capture capability, the manner in which the emergency call signaling is routed.

Although primarily depicted and described herein with respect to embodiments in which an ECC 130 routes emergency call signaling toward a multimedia PSAP when a determination is made that the UD from which the emergency call is received supports a media content capture capability, it is noted that in one embodiment an ECC 130 also may be configured to initiate establishment of a media session between the UD and the multimedia PSAP when a determination is made that the UD from which the emergency call is received supports a media content capture capability. In such embodiments, initiation of establishment of such a media session may include appropriate routing of received emergency call signaling, initiation of new signaling for establishing a media session between the UD and the multimedia PSAP, and the like, as well as various combinations thereof.

As described herein, following establishment of a media session capable of transporting media content between the UD 102 and multimedia PSAP 124, various additional capabilities may be supported in conjunction with review and analysis of the received media content, appropriate sharing of the media content, ensuring availability of the media session under various conditions, and the like, as well as various combinations thereof.

In one embodiment, at least a portion of the media content may be reviewed by one or more emergency services operators at the multimedia PSAP 124 to which the media content is directed. The emergency services operator(s) at the multimedia PSAP 124 could use the media content, alone or in combination with associated voice content, to assess the situation and take appropriate actions. For example, the emergency services operator(s) at the multimedia PSAP 124 could use the media content to determine which emergency response personnel and/or equipment to dispatch to the scene (e.g., local and/or state police, ambulance, fire rescue and/or fire ladder trucks, hazmat teams, the FBI, Homeland Security, FEMA, and the like), to instruct the user associated with the UD 102 as to what actions he or she can take in response to the emergency, to determine proper forwarding of the media content (e.g., to the emergency services personnel who may be assisting with the emergency), and the like, as well as various combinations thereof.

In one embodiment, at least a portion of the media content may be forwarded to emergency services personnel who may be assisting with the emergency (e.g., emergency services personnel en route to the scene of the emergency, medical personnel at hospitals expected to treat people being transported from the scene of the emergency, and the like). For example, where media content is forwarded to emergency services personnel en route to the scene of the emergency, the emergency services personnel can use the media information to assess the situation and to create/modify a strategy while traveling to the site, thereby enabling them to put the appropriate response into action upon arrival at the scene of the emergency. For example, where media content is forwarded to medical personnel at hospitals expected to treat people being transported from the scene of the emergency, the medical personnel can use the media information to assess the injuries of people being transported to the hospital, and, thus, to prepare staff, treatments, equipment, and the like. The forwarding of media content in this manner may be initiated automatically, manually by emergency services operators at the multimedia PSAP 124, and the like, as well as various combinations thereof. The forwarding of media content in this manner may be provided in any suitable manner (e.g., via establishment and use of data sessions to one or more mobile devices of one or more of the emergency services personnel, where the data session(s) may be established via any suitable communication networks).

In one embodiment, a capability is provided to reestablish the media session between multimedia PSAP 124 and UD 102 when the media session between multimedia PSAP 124 and UD 102 is terminated. It is noted that the media session between multimedia PSAP 124 and UD 102 may be terminated, accidentally or purposefully, for any number of reasons (e.g., there is a problem with the session, the caller accidentally ends the session or presses the power off button, a criminal takes the UD 102 from the caller to prevent the caller from communicating with the emergency services operator and either terminates the call or turns off the UD 102, and the like).

The reestablishment of the session may be initiated automatically (e.g., by one or more network elements in response to detecting termination or the session) or manually (e.g., by an emergency services operators at the PSAP).

In one embodiment, where the media session is reestablished, the UD 102 may be configured to provide an indication of session reestablishment via the UD 102. For example, the UD 102 may provide an indication of reestablishment of the media session via one or more of an audible indication, a visual indication (e.g., lighting up a display screen of the UD 102, displaying a message via a display screen of the UD 102, and the like), causing the UD 102 to vibrate, and the like, as well as various combinations thereof. This may be useful in various situations. For example, this may be useful where the user of UD 102 is not being threatened by any criminals and may not realize that the session was inactive for a period of time, thereby enabling the user of UD 102 to ensure that specific information is communicated to emergency services personnel via the media session.

In one embodiment, where the media session is reestablished, the UD 102 may be configured to suppress any indication of session reestablishment via the UD 102. For example, the UD 102 may be configured to silently accept the session reestablishment request without any associated audible or visible indicators being provided on UD 102. This may be useful in various situations. For example, this may be useful where a criminal took the UD 102 away from the caller and ended the call or turned the phone off to terminate the call to emergency services, thereby enabling the PSAP operator to assess the situation and determine the appropriate response action without the knowledge of the criminal.

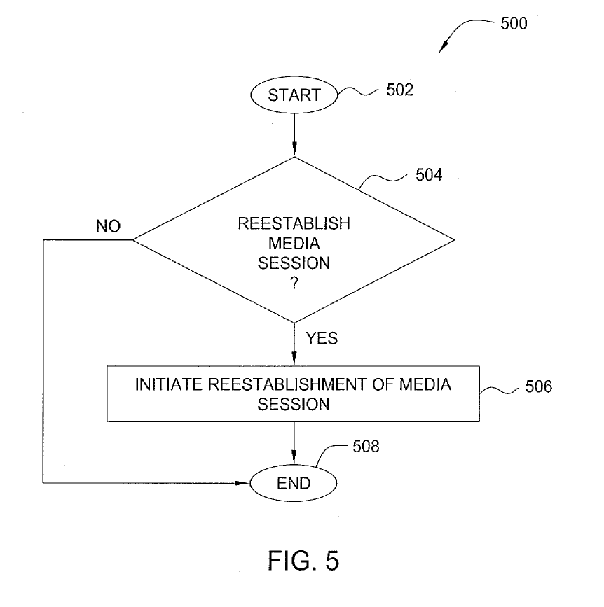

FIG. 5 depicts one embodiment of a method for reestablishing a media session of a multimedia emergency call. It is noted that the media session may be a media session (including only media content without associated voice content) or a multimedia session (including both media content and voice content).

At step 502, method 500 begins.

At step 504, a determination is made as to whether or not to reestablish the media session previously established between UD 102 and multimedia PSAP 124.

In one embodiment, for example, the determination is made in response to detection of a condition associated with the media session (e.g., lost packets or other errors) or detection that the media session has terminated.

In one embodiment, for example, the determination is made via detection of a request by an emergency services operator to initiate reestablishment of the media session (e.g., which may be requested via a user interface of a multimedia operator terminal of multimedia PSAP 124).

In one embodiment, for example, the determination is made, by the element that is performing step 504, in response to signaling received from another element (e.g., in response to signaling received at IMS Session Controller 117 from a multimedia operator terminal of multimedia PSAP 124, in response to signaling received at Service Broker 116 from at IMS Session Controller 117 and/or multimedia PSAP 124, and the like).

If a determination is made not to reestablish the media session previously established between UD 102 and multimedia PSAP 124, method 500 proceeds to step 508, where method 500 ends.

If a determination is made to reestablish the media session previously established between UD 102 and multimedia PSAP 124, method 500 proceeds to step 506.

At step 506, reestablishment of the media session is initiated, which includes sending of session reestablishment signaling configured for enabling the media session between the UD 102 and the multimedia PSAP 124 to be reestablished.

The media session reestablishment signaling may be initiated and propagated in any suitable manner, which may depend on the element at which step 506 is performed. In one embodiment, for example, in which step 506 is performed by a multimedia operator terminal 125 of multimedia PSAP 124, the signaling may be sent from multimedia operator terminal 125 toward IMS Session Controller 117 for propagation of appropriate media session reestablishment signaling toward the UD 102 (illustratively, via IP network 115, MNPC 114, and so forth). In one embodiment, for example, in which step 506 is performed by IMS Session Controller 117, the signaling may be sent from IMS Session Controller 117 toward Service Broker 116 for propagation of appropriate media session reestablishment signaling toward the UD 102. In one embodiment, for example, in which step 506 is performed by IMS Session Controller 117, the signaling may be sent from 1MS Session Controller 117 toward Service Broker 116 for propagation of appropriate media session reestablishment signaling toward the UD 102 (illustratively, via IP network 115, MNPC 114, and so forth). In one embodiment, for example, in which step 506 is performed by Service Broker 116, the signaling may be sent from Service Broker 116 toward IMS Session Controller 117 for propagation of appropriate media session reestablishment signaling toward the UD 102 (illustratively, via IP network 115, MNPC 114, and so forth).

The media session reestablishment signaling may be configured to provide an indication to the UD 102 as to whether reestablishment of the media session is to be announced by the UD 102 (e.g., via one or more of ringing, vibrating, display of lights and/or messages, and the like) or whether notification of reestablishment of the media session is to be suppressed by the UD 102.

At step 508, method 500 ends. Although depicted and described herein as ending (for purposes of clarity), it is noted that the media session reestablishment signaling initiated at step 506 of method 500 may then be propagated and any appropriate steps needed to reestablish the connection may be performed by the appropriate elements. For example, the media session reestablishment signaling may be propagated to UD 102, which may then process the media session reestablishment signaling and respond to the media session reestablishment signaling in a manner suitable for enabling the media session to be reestablished. For example, other types of signaling may be performed (e.g., between UD 102 and an element(s) of the cellular/IMS communication infrastructure 110, between elements of the cellular/IMS communication infrastructure 110, between elements of the cellular/IMS communication infrastructure 110 and multimedia PSAP 124, and the like) for enabling the media session to be reestablished.

From the description of method 500, it will be appreciated that the steps of method 500 may be performed by a single network element or may be distributed across and performed by multiple network elements. For example, the steps of method 500 may be distributed across one or more of a multimedia operator terminal 125 of the multimedia PSAP 124, the IMS Session Controller 117, the Service Broker 116, one or more other elements of cellular/IMS communication infrastructure 110, and the like, as well as various combinations thereof).

Although primarily depicted and described herein with respect to embodiments in which the media session reestablishment is initiated and controlled by one or more network elements, in at least one embodiment the UD 102 may be configured to automatically initiate reestablishment of the media session between the UD 102 and multimedia PSAP 124. In at least some embodiments, UD 102 may be configured to initiate reestablishment of the media session in response to a trigger condition (e.g., in response to detecting that the media session has terminated without a user of UD 102 requesting that the media session be terminated, or in response to any other suitable condition). In at least some such embodiments, the UD 102 may initiate media session reestablishment signaling which may then be propagated by cellular/IMS communication infrastructure 110 in a manner for enabling the reestablishment of the media session between UD 102 and multimedia PSAP 124.

Although primarily depicted and described herein with respect to reestablishment of the media session with the UD 102 (e.g., some session at least including media content), it is noted that a similar capability may be provided for enabling reestablishment of a voice session with the UD 102 (i.e., a voice-only session). It is noted that reestablishment of a voice session may be performed either independent of or in combination with reestablishment of the media session.

Although primarily depicted and described herein with respect to handling of a single multimedia emergency call by multimedia PSAP 124, it is noted that multiple multimedia emergency calls may be handled at multimedia PSAP 124 at any given time. This may include multimedia emergency calls which have been answered by emergency services operators at multimedia PSAP 124, and also may include pending multimedia emergency calls waiting to be accepted and handled by multimedia emergency services operators at multimedia PSAP 124 (e.g., depending on the number of pending multimedia emergency calls and the number of multimedia operator terminals 125 available at multimedia PSAP 124). In one embodiment, pending multimedia emergency calls may be maintained in a queue at multimedia PSAP 124, where the queue may be implemented at multimedia PSAP 124 in any suitable manner (e.g., at a server or any other type of device suitable for maintaining a queue of pending calls for multimedia PSAP 124). The pending multimedia emergency calls may be queued within the queue in any suitable manner (e.g., using a first-in-first-out scheme and/or using any other suitable type of queuing management scheme(s)). In at least some embodiments, for example, media content received via one or more of the pending multimedia emergency calls may be used for managing the queue of pending multimedia emergency calls (e.g., using media content received prior to voice communications between the user and the emergency services operator as a basis for moving pending multimedia emergency calls up and/or down in the queue as appropriate). For example, where media content provided from UD 102 to multimedia PSAP 124 includes smoke and/or other indicators of a fire, automated recognition of the possible presence of a fire may result in a determination that the emergency is a dangerous situation and, therefore, that the multimedia emergency call should be prioritized over at least some of the other multimedia emergency calls in the queue of pending multimedia emergency calls. It is noted that the foregoing examples represent only a few examples of the many ways in which various types of media content may be processed and analyzed for managing the queue of pending multimedia emergency calls at multimedia PSAP 124. It is further noted that such embodiments would be useful in many situations, including any situations in which a relatively high volume of emergency calls is received (e.g., for large emergencies such as earthquakes, tornadoes, and the like).

As described herein, various embodiments of the multimedia emergency call capability provide significant improvements over existing emergency calling services which are limited to voice connections to the party reporting an emergency situation, since voice-only conversations cannot describe a situation as quickly or completely as media content such as photos and/or video. Accordingly, it is noted that various embodiments of the multimedia emergency call capability provide advantages such as one or more of (1) providing additional, and much richer and more valuable, content to emergency services operators (e.g., thereby allowing faster dispatch of appropriate personnel and equipment to emergency situations) and/or emergency services responders/personnel (e.g., thereby allowing for faster and better preparation and, thus, better responses to emergency situations), (2) providing emergency services responders and/or personnel with additional time for preparation (e.g., where emergency services responders receive media content en route to the scene of the emergency, where emergency services personnel receive media content prior to the time at which they need to help with handling of the emergency, and the like), (3) providing optimal routing of emergency calls based on the UD capabilities (e.g., camera phone) and PSAP equipment (e.g., video monitor), which also allows for a gradual transition to enhanced services as PSAPs are upgraded and smart phones increase in popularity among consumers, (4) providing peace of mind to end users who would benefit from knowing that they have enhanced capabilities with which to seek help in emergency situations, (5) providing cellular operators with the capability to offer this as a value-added service to customers, and (6) providing government entities with cost savings by enabling government entities to better control dispatching of personnel and equipment in accordance with the given situation. Various other advantages of the multimedia emergency call capability will be appreciated from the descriptions of various embodiments provided herein.

Although primarily depicted and described herein with respect to embodiments in which a voice-based emergency call is supplemented with media content, it is noted that, in one or more embodiments, a voice-based emergency call may be supplemented with one or more other types of information which may be in place of or in addition to media content. In one embodiment, for example, one or more data sessions may be established between the UD and an enhanced PSAP for providing one or more of UD geo-location information, wireless signal strength information (e.g., RF and/or Win), temperature readings, barometric pressure readings, orientation of the UD (e.g. tilt, compass heading, and the like), accelerometer readings from an internal accelerometer of the UD, address book/contact list information from the UD, and the like, as well as various combinations thereof.

As noted herein, although primarily depicted and described with respect to embodiments of a multimedia emergency call capability, it is noted that the multimedia call capability may include various other embodiments, such as other types of multimedia emergency call capabilities, a multimedia security call capability (e.g., embodiments of the multimedia call capability in which the call is a security call, which may or may not be associated with an emergency, that is directed to a private safety answering point), or any other capabilities in which a data session is established for use in propagating media content from a user device in conjunction with a call.

In one embodiment, for example, in the case of a home security system in a home being monitored by a security company, the triggering of an alarm of the home security system may result in establishment of a voice call between a user device in the home and an operator at the security company. The call may be initiated manually by the user in the home, automatically by the home security system in the home, manually by the operator at the security company, automatically from the security company, and the like. In this case, an associated data session may be established between the user device and a multimedia terminal at the security company, such that media content may be provided to the security company for use in assessing the situation (e.g., a need to call the police, an ambulance, the fire department, and/or any other type of response that may be needed at the home).

In one embodiment, for example, in the case of a fire monitoring system in a building being monitored by a fire monitoring company, the triggering of a fire alarm of the fire monitoring system may result in the establishment of one or more data sessions between one or more devices at the building and one or more systems at the fire monitoring company. For example, a data session may be established between a video camera of the fire monitoring system at the building and a multimedia terminal at the fire monitoring company, such that video may be provided to the fire monitoring company. For example, a data session may be established between a sensor controller of the fire monitoring system at the building (e.g., a sensor controller receiving sensor readings from one or more sensors in the building (e.g., temperature sensors and/or any other suitable types of sensors) and a monitoring system at the fire monitoring company, such that the sensor readings may be provided to the fire monitoring company. In this case, the private monitoring company may then contact the fire department to request dispatch of the first department to the building, send information regarding the details of the fire to the fire department (e.g., via a verbal description of the situation, by forwarding video which may be reviewed by the fire department for use in preparing to respond to the fire, and the like).

It is noted that, since the multimedia call capability may be considered to include various types of capabilities (e.g., a multimedia emergency call capability, a multimedia security call capability, and the like), various elements of and/or terms used in conjunction with description of communication system 100 (which is primarily depicted and described within the context of providing embodiments of a multimedia emergency call capability) may be referred to more generally. For example, emergency calls may be referred to more generally as calls. For example, PSAP 120 may be referred to more generally as an answering point (and, similarly, voice-based PSAP 122 and multimedia PSAP 124 may be referred to more generally as a voice-based answering point and a multimedia answering point, respectively). For example, the ECCs 130 may be referred to more generally as call controllers. It is noted that other elements and/or terminology used herein also may be generalized to encompass various other types of multimedia call capabilities.

Although primarily depicted and described herein with respect to embodiments in which the data session is established for the user device associated with the call (e.g., from which the call is initiated, to which the call is placed, and the like), in one embodiment the call may be associated with a first user device and the data session may be associated with a second user device. For example, an emergency call may be initiated by a user while in his or her home using his or her cell phone, which may result in establishment of a data session with a video camera located in the home of the user (e.g., the voice and data sessions terminate on different devices of the end user). For example, an operator of a private security company may call the cell phone of a user in response to an indication of an alarm on the home security system of the user and, further, a data session may be established with a video camera of the home security system (e.g., initiated by the home security system in response to detecting an indication of an alarm, initiated by the private security company in response to detecting an indication of an alarm, and the like). In this manner, in at least some embodiments, the voice portion of the call may be decoupled from the data portion of the call in terms of the user devices supporting the respective portions of the call.

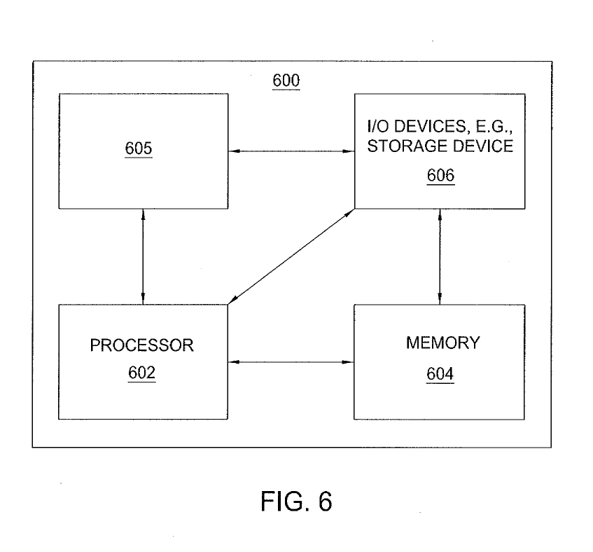

FIG. 6 depicts a high-level block diagram of a computer suitable for use in performing functions described herein.

As depicted in FIG. 6, computer 600 includes a processor element 602 (e.g., a central processing unit (CPU) and/or other suitable processor(s)) and a memory 604 (e.g., random access memory (RAM), read only memory (ROM), and the like). The computer 600 also may include a cooperating module/process 605 and/or various input/output devices 606 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software (e.g., via implementation of software on one or more processors) and/or hardware (e.g., using a general purpose computer, one or more application specific integrated circuits (ASIC), and/or any other hardware equivalents).

It will be appreciated that the functions depicted and described herein may be implemented in software for executing on a general purpose computer (e.g., via execution by one or more processors) so as to implement a special purpose computer, and/or may be implemented in hardware (e.g., using one or more application specific integrated circuits (ASIC) and/or one or more other hardware equivalents).

In one embodiment, the cooperating process 605 can be loaded into memory 604 and executed by processor 602 to implement functions as discussed herein. Thus, cooperating process 605 (including associated data structures) can be stored on a computer readable storage medium, e.g., RAM memory, magnetic or optical drive or diskette, and the like.

It will be appreciated that computer 600 depicted in FIG. 6 provides a general architecture and functionality suitable for implementing functional elements described herein and/or portions of functional elements described herein. For example, the computer 600 provides a general architecture and functionality suitable for implementing one or more of UD 102, MSC 113, Service Broker 116, IMS Session Controller 117, subscriber database 118, a voice-based operator terminal 123 associated with voice-based PSAP 122, a multimedia operator terminal 125 associated with multimedia PSAP 124, ECC 130₁, ECC 130₂, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. An apparatus, comprising:
a processor and a memory, the processor configured to:
initiate a call from a user device supporting a media content capture capability;
receive, at the user device, a request for establishment of a data session between the user device and a multimedia answering point; and
propagate media content captured at the user device toward the multimedia answering point via the data session.

2. The apparatus of claim 1, wherein the processor is further configured to:
send, from the user device toward the multimedia answering point, a request to provide media content via the data session; and
in response to a reply from the multimedia answering point indicative that the user device may provide media content via the data session, capture media content at the user device.

3. The apparatus of claim 1, wherein the processor is further configured to:
receive, at the user device, an instruction to provide media content via the data session; and
in response to the instruction, capture media content at the user device.

4. The apparatus of claim 1, wherein the processor is further configured to:
after termination of the data session, receive a request for reestablishment of the data session between the user device and the multimedia answering point.

5. The apparatus of claim 4, wherein the processor is further configured to:
in response to the request for reestablishment of the data session to the user device, suppress notification of the request at the user device.

6. A method, comprising:
using a processor and a memory for:
initiating a call from a user device supporting a media content capture capability;
receiving, at the user device, a request for establishment of a data session between the user device and a multimedia answering point; and
propagating media content captured at the user device toward the multimedia answering point via the data session.

7. The method of claim 6, further comprising:
sending, from the user device toward the multimedia answering point, a request to provide media content via the data session; and
in response to a reply from the multimedia answering point indicative that the user device may provide media content via the data session, capturing media content at the user device.

8. The method of claim 6, further comprising:
receiving, at the user device, an instruction to capture media content and provide the captured media content via the data session; and
in response to the instruction, capturing media content at the user device.

9. The method of claim 6, further comprising:
after termination of the data session, receiving a request for reestablishment of the data session between the user device and the multimedia answering point.

10. The method of claim 9, further comprising:
in response to the request for reestablishment of the data session to the user device, suppressing notification of the request at the user device.

11. An apparatus, comprising:
a processor and a memory, the processor configured to:
receive call signaling indicative of a call initiated from a user device to an answering point;
determine whether the user device supports a media content capture capability; and
determine routing of the call signaling based on the determination as to whether the user device supports a media content capture capability.

12. The apparatus of claim 11, wherein the processor is configured to determine whether the user device supports a media content capture capability using a network-based profile associated with the user device.

13. The apparatus of claim 11, wherein the processor is configured to:
when a determination is made that the user device does not support a media content capture capability, route the call signaling toward a voice-based answering point).

14. The apparatus of claim 11, wherein the processor is configured to:
when a determination is made that the user device does support a media content capture capability, route the call signaling toward a multimedia answering point.

15. The apparatus of claim 11, wherein the processor is configured to determine routing of the call based on the determination as to whether the user device supports a media content capture capability by:
determining whether a multimedia answering point is available; and
routing the call toward a voice-based answering point when a determination is made that a multimedia answering point is not available or routing the call toward a multimedia answering point when a determination is made that a multimedia answering point is available.

16. An apparatus, comprising:
a processor and a memory, the processor configured to:
receive, at a multimedia answering point, call signaling indicative of a call initiated from a user device; and
initiate establishment of a data session configured for propagating media content from the user device toward the multimedia answering point.

17. The apparatus of claim 16, wherein the media content comprises at least one of a photograph and video.

18. The apparatus of claim 16, wherein the processor is further configured to:
propagate, toward the user device, an instruction for the user device to capture media content and provide the captured media content to the multimedia answering point via the data session.

19. The apparatus of claim 16, wherein the processor is further configured to:
in response to a determination that the data session has terminated, initiate reestablishment of the data session between the user device and the multimedia answering point.

20. The apparatus of claim 16, wherein the processor is further configured to:
initiate presentation of the media content via at least one presentation interface of an operator terminal of the multimedia answering point.

21. An apparatus, comprising:
a processor and a memory, the processor configured to:
receive a request to reestablish a data session between a multimedia answering point and a user device, wherein the data session is associated with a call initiated from the user device; and
propagate signaling configured to request reestablishment of the data session between the multimedia answering point and the user device.

22. The apparatus of claim 21, wherein the request is received at a Service Broker of an Internet Protocol (IP) Multimedia Subsystem (IMS) network.

23. The apparatus of claim 21, wherein the request is received from the user device and the signaling is propagated toward the multimedia answering point.

24. The apparatus of claim 21, wherein the request is received from the multimedia answering point and the signaling is propagated toward the user device.

25. The apparatus of claim 21, wherein the signaling comprises an indication to the user device that notification of the request is to be suppressed by the user device.
